(19) United States
(12) Patent Application Publication
(10) Pub. No.: US 2014/0304817 A1
(43) Pub. Date: Oct. 9, 2014

(54) APPARATUS AND METHOD FOR DETECTING SLOW READ DoS ATTACK

(71) Applicant: Electronics and Telecommunications Research Institute, Daejeon (KR)

(72) Inventors: Byoung-Koo KIM, Daejeon (KR); Yangseo CHOI, Daejeon (KR); Ik Kyun KIM, Daejeon (KR)

(73) Assignee: Electronics and Telecommunications Research Institute, Daejeon (KR)

(21) Appl. No.: 14/154,888

(22) Filed: Jan. 14, 2014

(30) Foreign Application Priority Data
Apr. 9, 2013 (KR) 10-2013-0038599

(51) Int. Cl. H04L 29/06

(52) U.S. Cl. CPC H04L 63/1408
USPC 726/23

(57) ABSTRACT

A method for detecting a slow read DoS attack in a virtualized environment, the method comprising: receiving a connection request packet transmitted from a client to a server using a web protocol; checking whether the received packet is a TCP SYN packet or a packet of an HTTP GET request message; when it is checked that the received packet is the packet of the HTTP GET request message, detecting whether the received packet is a packet for the slow read DoS attack by analyzing a window size of the HTTP GET request message.

### RELATED APPLICATIONS

This application claims the benefit of Korean Patent Application No. 10-2013-0038599, filed on Apr. 9, 2013, which is hereby incorporated by reference as if fully set forth herein.

### FIELD OF THE INVENTION

The present invention relates to a detection of DDoS (distributed denial of service) attack to block a normal HTTP connection, and more particularly, to an apparatus and method for detecting a slow read DoS (Denial Of Service) attack in a virtualized environment, which is capable of detecting a slow read DoS attack more quickly by classifying HTTP GET request messages of a normal user and a malicious user to respond thereto, in consideration of correlation and feature of a window size of a TCP SYN packet in a process of establishing a TCP connection required in an HTTP connection and a window size of a HTTP GET request message transferred in the same session, to thereby protect a web server from a web server overload attack such as a slow read DoS attack and provide a smooth service to the normal user.

### BACKGROUND OF THE INVENTION

In general, a DDoS (distributed denial of service) attack is called an attack that paralyzes a target site through traffic attacks that the target site cannot afford by exploiting a large amount of zombie PCs. However, in recent years, it has been demonstrated that a DoS (Denial Of Service) attack can be made with only few PCs and such a DoS attack is able to paralyze a target website with few numbers of PCs through the concept of a slow read DoS attack.

An attack method that is called a slow read is to make a server to react to an HTTP request very slowly. When this attack method is utilized, a number of zombie PCs is unnecessary for DoS attacks. This attack is fatal in the default settings of Apache, which is popular web server software, and is also a weak point of Nginx HTTP server and Lighttpd Web server.

Such a slow read attack is achieved with an open-source slowhttptest tool and takes a different approach from the slowloris that is one of existing slow attacks. A form of an existing slow attack forces a web server to receive a portion of HTTP requests to block network ports of the web server, whereas a form of the slow read DoS attack sends complete HTTP requests to the server, but allows the server to read them very slowly, so that the server does not react to the HTTP requests. In this attack, known vulnerabilities of a TCP protocol are exploited, an attacker is able to control the flow of data and delay the transfer.

In other words, the slow read DoS attack, like as the slowloris and slow POST attacks, is the denial of service attack for the purpose of resource depletion of the system. An attacker diminishes a window size of an HTTP GET request to delay a receiving rate of an HTTP response and deplete connection resources with a web server. Since the slow read DoS attack does not violate the rules of the TCP protocol, it is difficult to determine attack traffic from a normal traffic.

FIGS. 1A and 1B illustrate a data transfer process between a client and a server in accordance with a window size in a prior art.

Referring to FIG. 1A, for example, it is assumed that an MTU (Maximum Transfer Unit) between a server 102 and a client 100 is 1,500 bytes, and the server 102 sends data of 4,500 bytes to the client 100. In a case where a window size is 1,500 bytes as shown in FIG. 1A, whenever the server 102 transmits every 1,500 bytes of data, the server 102 receives a data receipt acknowledge (ACK) from the client 100. In contrast, in a case where a window size is 4,500 bytes as shown in FIG. 1B, the server 102 receives a data receipt acknowledgment (ACK) from the client 100 after sending all the data. The term ‘window size’ used herein refers to a data size that the server 102 such as a web server can transmit continuously without waiting for a receipt acknowledgment (ACK) from the client 100. The window size may have different values depending on an environment, and may be set to a maximum 65,535 bytes.

In this case, if an attacker diminishes window sizes arbitrarily and sends HTTP GET requests to a target server of attack, the attacker and the target server occupy connection resources until the data transfer is complete. Put it another way, if this process as described above is outbreak, the connection resources of the target server are exhausted and thus the target server falls into the denial of service. Measures against this attack is to shut off the flow of data that is unusually small and set a time limit for online on the Internet, but these measures have a problem that is hard to be a fundamental solution.

### SUMMARY OF THE INVENTION

In view of the above, the present invention provides an apparatus and method for detecting a slow read DoS attack in a virtualized environment, which is capable of detecting the slow read DoS attack more quickly by classifying HTTP GET request messages of a normal user and a malicious user, in consideration of correlation and feature of a window size of a TCP SYN packet in a process of establishing a TCP connection required in an HTTP connection and a window size of a HTTP GET request message transferred in the same session, to thereby protect a web server from a web server overload attack such as the slow read DOS attack and provide a smooth service to the normal user.

In accordance with an embodiment of the present invention, there is provided a method for detecting a slow read DoS attack in a virtualized environment, which includes: receiving a connection request packet transmitted from a client to a server using a web protocol; checking whether the received packet is a TCP SYN packet or a packet of an HTTP GET request message; when it is checked that the received packet is the packet of the HTTP GET request message, detecting whether the received packet is a packet for the slow read DoS attack by analyzing a window size of the HTTP GET request message.

In the embodiment, wherein said detecting comprises: when it is checked that the received packet is the HTTP GET request message, comparing the window size of the HTTP GET request message and a window size of the TCP SYN packet that has been stored previously; and as a result of the comparison, when the window size of the HTTP GET request message is the same as the window size of the TCP SYN packet that has been stored previously, determining that the received packet is a packet for the slow read DoS attack.

In the embodiment, wherein said detecting comprises: as a result of the comparison, when the window size of the HTTP GET request message is smaller than the window size of the TCP SYN packet that has been stored previously, determining that the received packet is a packet for the slow read DoS attack.

In the embodiment, wherein said detecting comprises: when it is checked that the received packet is the HTTP GET request message, checking whether there exists the same SIP and DIP pair in the HTTP GET request message and a matching table; when it is checked that there exists the same SIP and DIP pair in the HTTP GET request message and a matching table, comparing the window size of the HTTP GET request message and a window size of an immediately preceding HTTP GET request message; and as a result of the comparison, when the window size of HTTP GET request message is less than or equal to a predetermined reference value relative to the window size of the immediately preceding HTTP GET request message, determining that the received packet is a packet for the slow read DoS attack.

In the embodiment, wherein said determining comprises: when the window size of the HTTP GET request message is less than or equal to 0.3 to 0.5 times the window size of an immediately preceding HTTP GET request message.

In the embodiment, wherein said checking comprises: when it is checked that the received packet is the TCP SYN packet, constituting a new entry in a matching table.

In accordance with an embodiment of the present invention, there is provided an apparatus for detecting a slow read DoS attack in a virtualized environment, which includes: a receiving unit configured to receive a packet that requests a connection with a server from a client using a web protocol; and an analysis unit configured to analyze, when the received packet is an HTTP GET request message, a window size of the HTTP GET request message to detect whether the received packet is a packet for the slow read DoS attack.

In the embodiment, wherein the analysis unit is configured to: compare, when the packet received from the receiving unit is the HTTP GET request message, a window size of the HTTP GET request message and a window size of a TCP SYN packet that has been stored previously; and determine, when the window size of the HTTP GET request message is the same as that of the TCP SYN packet, that the received packet is a packet for the slow read DoS attack.

In the embodiment, wherein the analysis unit is configured to: compare, when the packet received from the receiving unit is the HTTP GET request message, the window size of the HTTP GET request message and the window size of the TCP SYN packet that has been stored previously; and determine, when the window size of the HTTP GET request message is smaller than that of the TCP SYN packet that has been stored previously, determining that the received packet is a packet for the slow read DoS attack.

In the embodiment, wherein the analysis unit is configured to: compare, when the packet received from the receiving unit is the HTTP GET request message and there exists the SIP and DIP pair in the HTTP GET request message and a matching table, the window size of the HTTP GET request message and a window size of an immediately preceding HTTP GET request message; and determine, when the window size of the HTTP GET request message is smaller than or equal to a predetermined reference value relative to the window size of the immediately preceding HTTP GET request message, that the received packet is a packet for the slow read DoS attack.

In the embodiment, wherein the receiving unit is configured to: determine, when the window size of the HTTP GET request message is less than or equal to 0.3 to 05 times the window size of the immediately preceding GET request message, that the received packet is a packet for the slow read DoS attack.

As describe above, in accordance with the embodiments of the present invention, in detecting the slow read DoS attack in a virtualized environment, in consideration of correlation and feature of a window size of a TCP SYN packet in a process of establishing a TCP connection required in HTTP connection and a window size of an HTTP GET request message transferred in the same session, HTTP GET request messages of a normal user and a malicious user are classified to respond thereto. Accordingly, the embodiments have a merit in that it is possible to detect the slow read DOS attack more quickly, thereby protecting a web server from a web server overload attack such as the slow read DOS attack and providing a smooth service to the normal user.

Further, in accordance with the embodiments of the present invention, there is provided a detection technology for capable of blocking malicious traffic quickly. Accordingly, the embodiments also have a merit in that it is possible to respond to an attack without an overload to a target web server of attack, which enables an effective cutting off of the load on the web server constructed in a virtualized environment and an efficient use of a limited resource of a virtualized server fast

### BRIEF DESCRIPTION OF THE DRAWINGS

The above and other objects and features of the present invention will become apparent from the following description of the embodiments given in conjunction with the accompanying drawings, in which:

FIGS. 1A and 1B illustrate a data transfer process between a client and a server in accordance with a window size in a prior art;

FIGS. 2A and 2B exemplarily illustrate features of a form of a slow read DoS attack by a slowhttptest tool;

FIGS. 3A and 3B show a header format of a TCP SYN packet and header information of the TCP SYN packet; respectively;

FIG. 4 shows an example of a technique for extracting an HTTP GET message;

FIG. 5 is a block diagram of an apparatus for detecting a slow read DoS attack in accordance with an embodiment of the present invention;

FIG. 6 is a control flow diagram illustrating a method for detecting a slow read DoS attack in accordance with an embodiment of the present invention;

FIG. 7 is an exemplary configuration of a matching table in accordance with an embodiment of the present invention;

FIG. 8 is a control flow diagram of a method for detecting a slow read DoS attack in accordance with another embodiment of the present invention;

FIG. 9 is a control flow diagram of a method for detecting a slow read DoS attack in accordance with further another embodiment of the present invention; and

FIG. 10 shows an exemplary configuration of a matching table in accordance with another embodiment of the present invention.

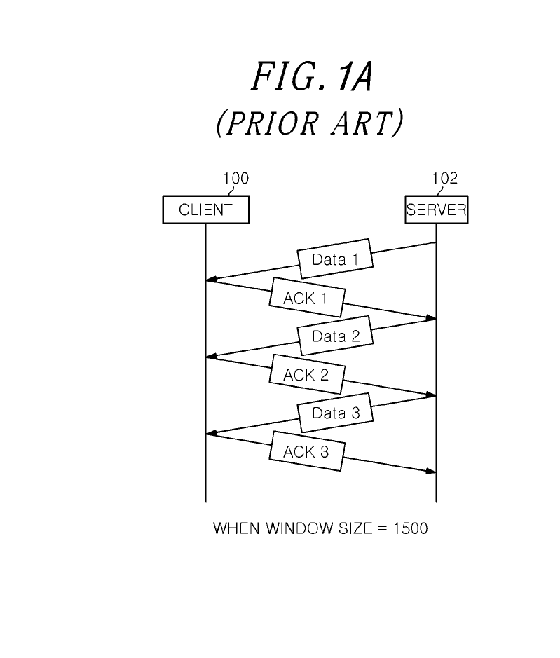

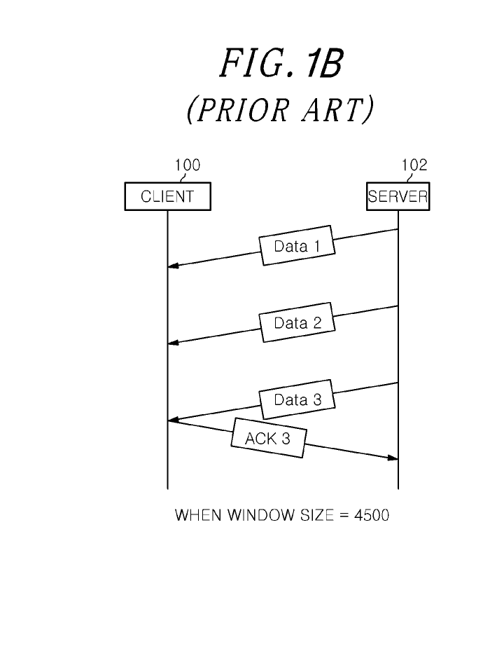

### DETAILED DESCRIPTION OF THE EMBODIMENTS

Hereinafter, the embodiments of the present invention will be described in detail with reference to the accompanying drawings. In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

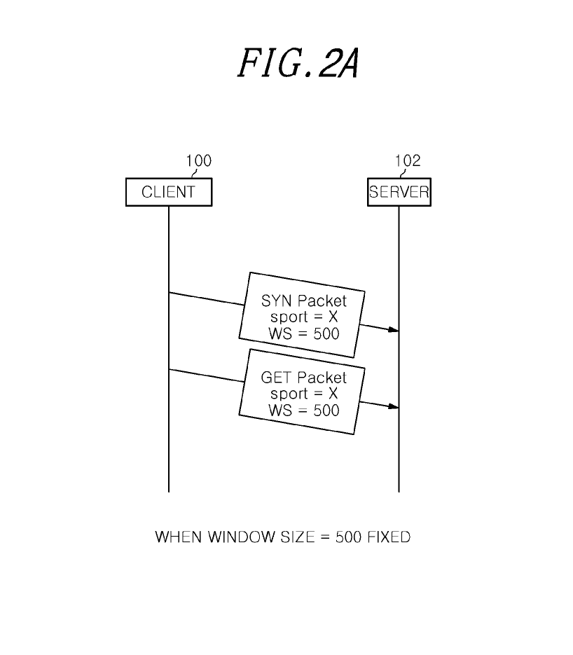

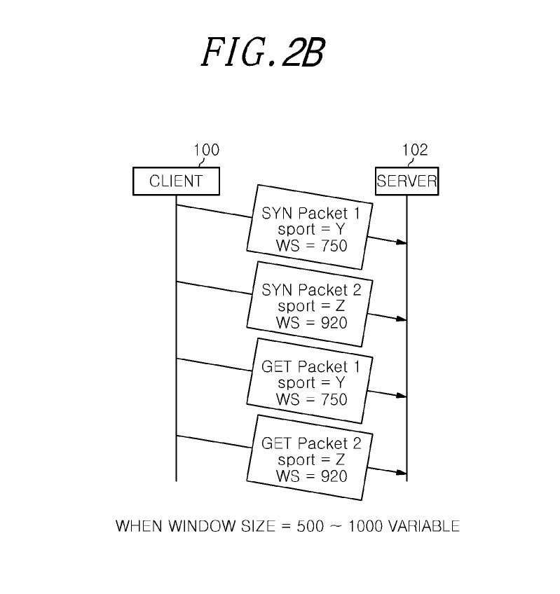

FIGS. 2A and 2B exemplarily illustrates a feature of a slow read DoS attack technique of a slowhttptest tool which is a representative tool for a slow read DoS attack.

As illustrated in the drawings, a slow read DoS attack indicates an attack in which an attacker fixes a window size arbitrarily to attempt to a HTTP GET access. FIG. 2A shows a shape of an attack in which the window size is fixed to 500 bytes, and FIG. 2B shows a shape of an attack in which the window size is set as a variable size between 500 and 1000 bytes.

Referring to FIGS. 2A and 2B, an attack feature of the slow read DoS attack is that a window size of a TCP SYN packet used when establishing a TCP session for sending an HTTP GET request message is the same as a window size of an actual HTTP GET request message in the same session. Therefore, this feature can take advantage as important information on detecting the slow read DoS attack.

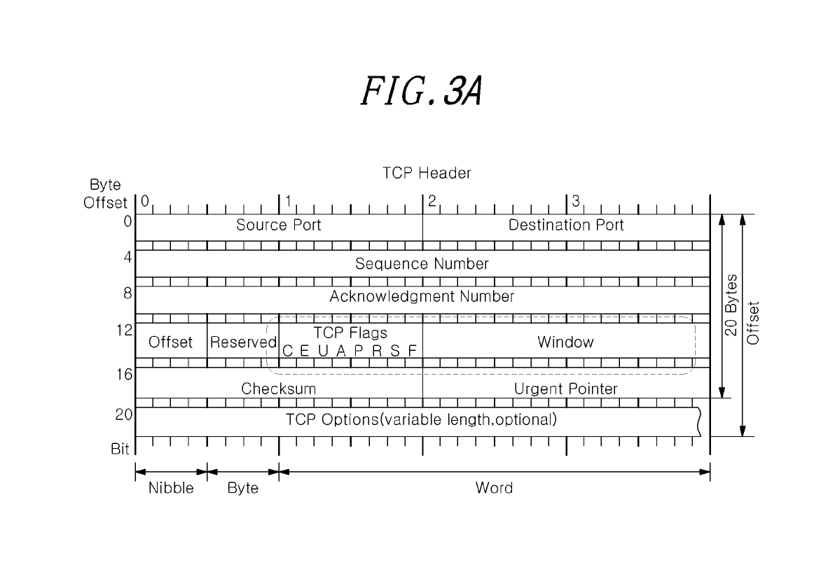

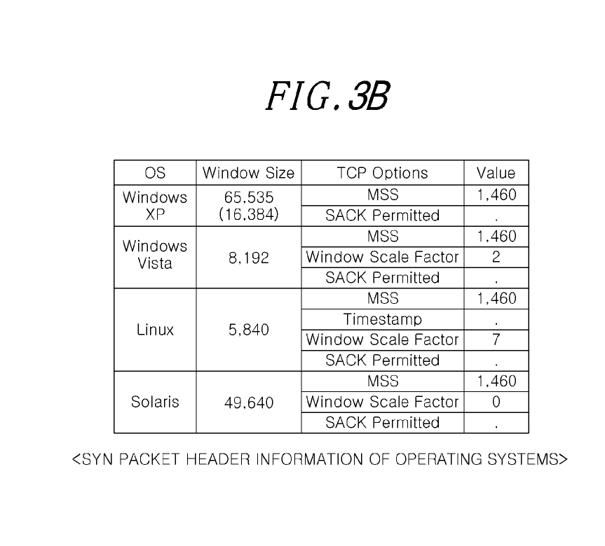

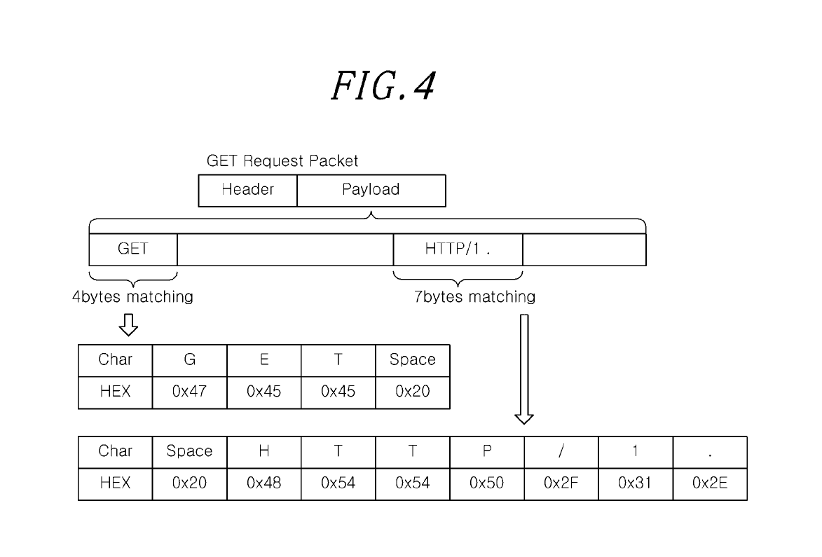

FIGS. 3A and 3B and FIG. 4 depict information that is needed to extract and analyze depending on the feature of FIG. 2.

First, FIG. 3A shows a classification method of a TCP SYN packet and a position of extracting the window size, and FIG. 3B shows the header information of TCP SYN packets of individual operating systems. Briefly, among HTTP service packets whose destination port is a value of 80, for example, a window size of packets in which a TCP flag of a TCP header is set to S is extracted for analyzing it. A typical window size of a TCP SYN packet is a minimum 5,840-byte and may be variable according to features of a system and transmission lines.

Next, FIG. 4 simply shows a technique to extract HTTP GET messages among packets belonging to the same session. As shown in FIG. 4, the HTTP GET request message has a payload that begins with “GET” and a string of “HTTP/1.” that exists following a URI content of 1-byte or more.

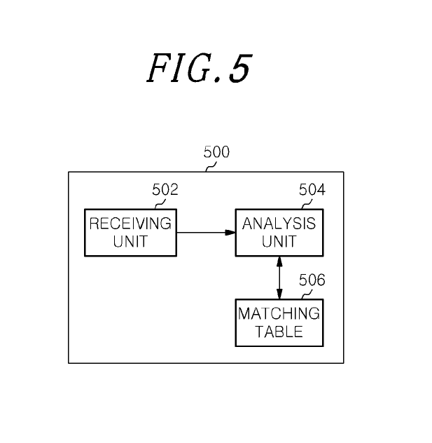

FIG. 5 is a detailed block of an apparatus for detecting a slow read DoS attack in a virtualized environment in accordance with an embodiment of the present invention. The apparatus for detecting slow read DoS attack 500 includes a receiving unit 502, an analysis unit 504 and a matching table 506. The apparatus 500 may be mounted within a server or disposed between the server and a communication network.

Hereinafter, the operation of the respective components of the apparatus for detecting a slow read DoS attack will described with reference to FIG. 5.

First, the receiving unit 502 receives packets sent from a client to a server.

The analysis unit 504 analyzes the packets received from the client through the receiving unit 502. When it is analyzed that a received packet is a TCP SYN packet, the analysis unit 504 constitutes a new entry in a matching table 506.

Further, when it is analyzed that the received packet is not the TCP SYN packet but is an HTTP GET request, the analysis unit 504 determines whether the received packet is a packet for the slow read DDoS attack using a plurality of predetermined methods. When it is determined it as the slow read DDoS attack, the analysis unit 504 blocks a HTTP service request of the packet to shut off the slow read DoS attack.

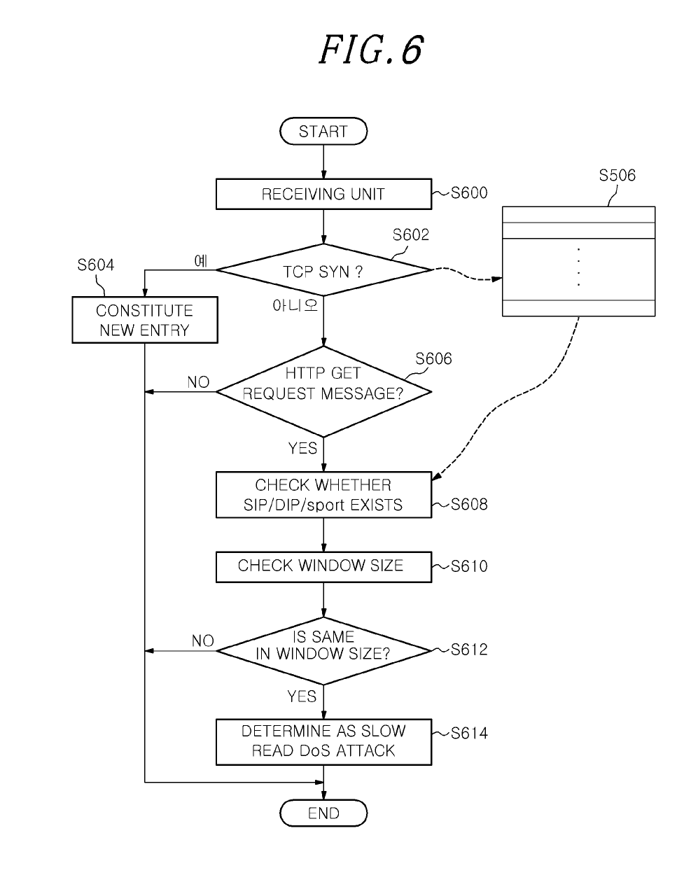

A method for determining a slow read DoS attack in the analysis unit 504 will be described with reference to control flow diagrams of FIGS. 6, 8 and 9 as follows.

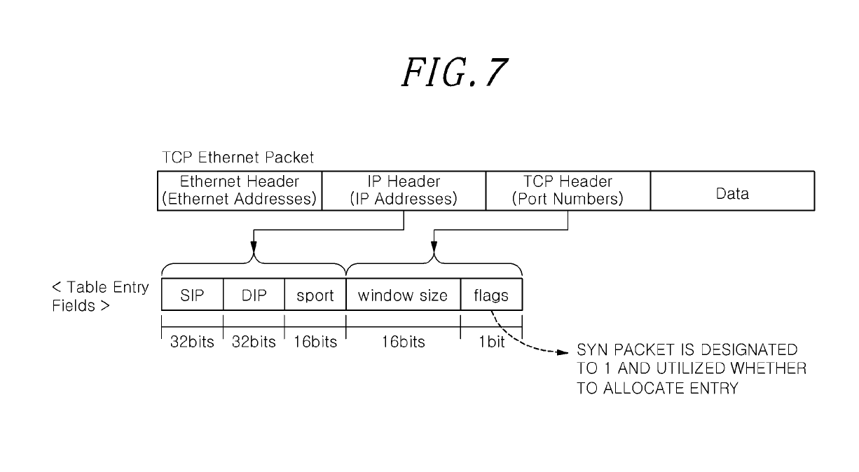

FIG. 6 is a control flow diagram illustrating a method for detecting a slow read DoS attack based on information extracted in FIGS. 3A, 3B and 4, and FIG. 7 illustrates a configuration of a matching table.

First, in the apparatus for detecting slow read DDoS attack 500, when an HTTP service packet in which a destination port is a value of 80 is received in an operation 5600, the analysis unit 504 checks whether the received packet is a TCP SYN packet, in an operation 5602.

However, when the received HTTP service packet is a TCP SYN packet, the analysis unit 504 constitutes a new entry in an operation 5604, adds the new entry to the matching table 506 and begins to analyze a succeeding packet.

When the received HTTP service packet is not the TCP SYN packet, the analysis unit 504 checks whether the received HTTP service packet is an HTTP GET request message, in an operation 5606. As a result of the check, when the received HTTP service packet is not the HTTP GET request message, the analysis unit 504 starts to analyze a succeeding packet.

However, As a result of the check, when the received HTTP service packet is the HTTP GET request message, the analysis unit 504 reads an entry which belongs to the same session (SIP/DIP/sport pair) from the matching table 506 in an operation 5608, and compares between a window size of the current HTTP GET request message and a window size of a SYN packet that has been stored previously, in an operation 5610.

As a result of the comparison, when the window size of the current HTTP GET request message is the same as that of the SYN packet, the analysis unit 504 determines that the received HTTP service packet is one for the slow read DoS attack, in an operation 5604. Here, in order that the slow read DoS attack gives loads on the server such as a web server, the better the window size is small. Therefore, it is more efficient to find out packets that meet a requirement of a window size below an MTU of 1,500 bytes, and such a limit setting may be adjusted by the administrator depending on a network environment for applying it. Further, the deletion of an entry created in the matching table 506 may be adjusted in accordance with the management of a TCP session.

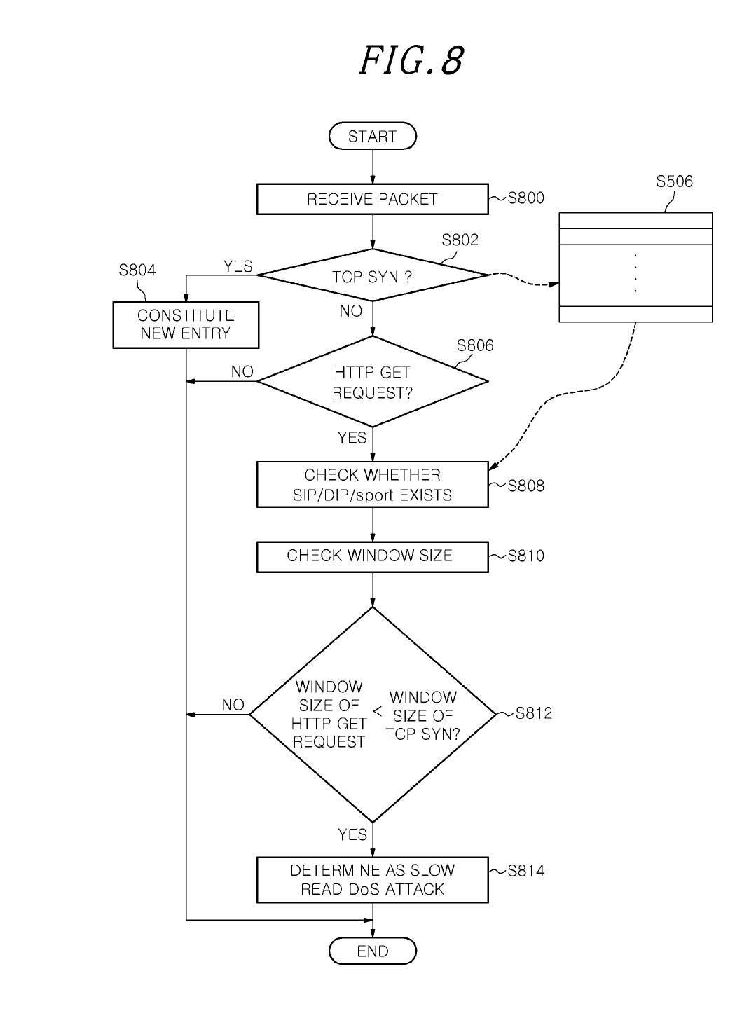

FIG. 8 is a control flow diagram of a method for detecting a slow read DoS attack, e.g., the slow read DDoS attack having a type in which a feature of slowhttptest tool is changed in accordance with another embodiment of the present invention. In particular, a description related to FIG. 8 will be made on a case where a window size of TCP SYN packets is unchanged but a window size of HTTP GET request messages is diminished.

Referring to FIG. 8, in the apparatus for detecting the slow read DoS attack 500, when an HTTP service packet is received, in an operation 5800, the analysis unit 504 checks whether the received packet is a TCP SYN packet, in an operation 5802.

When the received HTTP packet is a TCP SYN packet, the analysis unit 504 constitutes a new entry, in an operation S804, adds the new entry to the matching table 506 and starts to analyze a succeeding packet.

However, when the received HTTP service packet is not the TCP SYN packet, the analysis unit 504 checks whether the received HTTP service packet is an HTTP GET request message, in an operation 5806. As a result of the check, when the received HTTP service packet is not the HTTP GET request message, the analysis unit 504 starts to analyze a succeeding packet.

However, as a result of the check, when the received HTTP service packet is the HTTP GET request message, the analysis unit 504 reads an entry which belongs to the same session (SIP/DIP/sport pair) from the matching table 506, in an operation 5808, and compares between a window size of the HTTP GET request message and a window size of a SYN packet that has been stored previously, in an operation 5810.

As a result of the comparison, when the window size of the HTTP GET request message is smaller than that of the SYN packet, in an operation 5812, the analysis unit 504 determines that the received HTTP service packet is a packet for the slow read DoS attack, in an operation 5814.

In general, almost every TCP SYN packet is transmitted in a window size as in FIGS. 3A and 3B. If so, it is common that the HTTP GET request message has a large window size much more than the TCP SYN packet. In other words, even the value of a general window size of 65,535 bytes looks like very large as the window size, but it may not be sufficient enough when the packet is transferred via a transmission medium with a high-speed throughput and long delay time.

Thus, the configuration and operation of the matching table are all the same in both embodiments of FIG. 6 and FIG. 8, in a comparison of the TCP SYN packet and the HTTP GET request message in the window size, if the window size of the HTTP GET request message is smaller than that of the TCP SYN packet, it can be determined that there occurs the slow read DoS attack. Similarly, as described in relation to in FIG. 6, it is efficient that a limit setting is applied based the policy of an administrator depending on a case where the window size of the HTTP GET request message is smaller than the maximum MTU or a network environment. In addition, the deletion of an entry may also be made in accordance with the management of a TCP session as in FIG. 6.

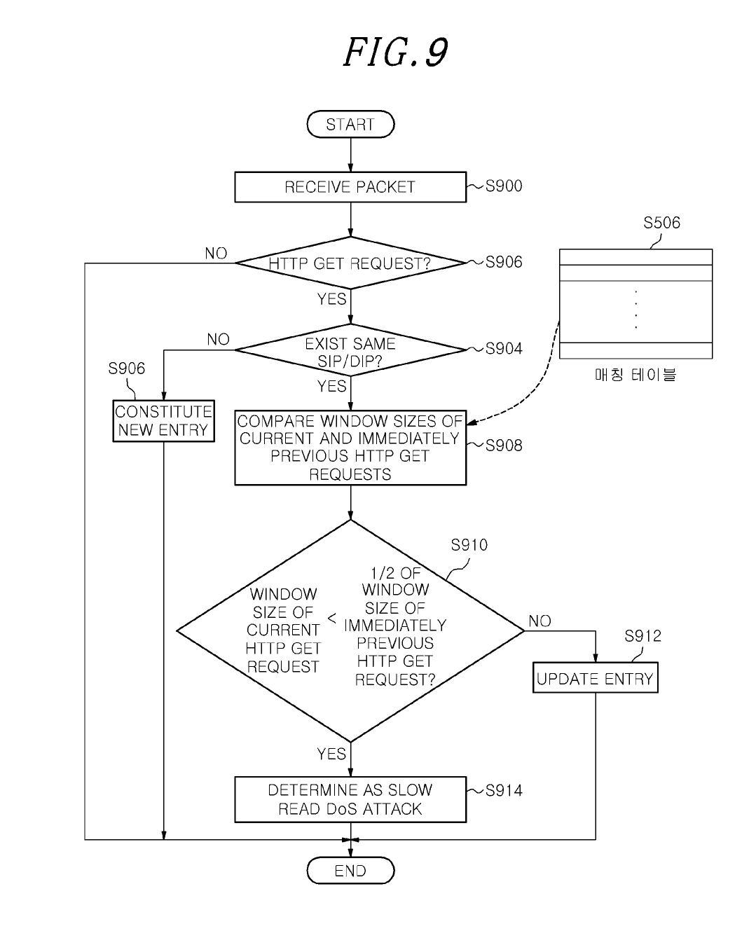

FIG. 9 is a control flow diagram of a method for detecting a slow read DoS attack, which detects the slow read DoS attack using a window size of an HTTP GET request irrespective of a TCP SYN packet in accordance with another embodiment of the present invention.

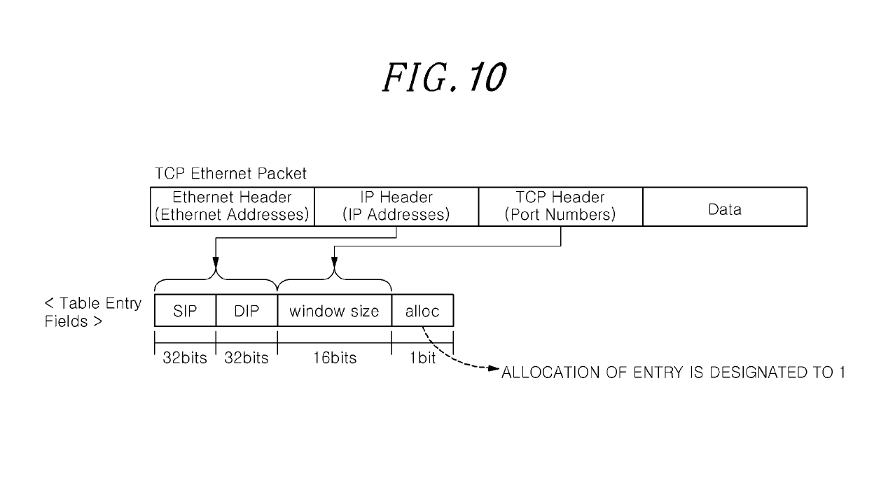

In order to detect the slow read DoS attack, the present embodiment of FIG. 9 uses only an entry of a SIP/DIP pair in a table shown in FIG. 10 as a matching table. That is, the present embodiment related to FIG. 9 traces a latest window size every SIP.

Hereinafter, the operation of the embodiment of FIG. 9 will be described in detail as below. First, in the apparatus for detecting the slow read DoS attack 500, when an HTTP service packet is received in an operation 5900, the analysis unit 504 checks whether the received packet is an HTTP GET request message, in an operation 5902.

When the received HTTP packet is the HTTP GET request message, the analysis unit 504 checks whether the matching table 506 has the same SIP/DIP pair in the HTTP GET request message, in an operation 5904. When it is checked that the same SIP/DIP pair does not exist in the matching table 506, the analysis unit 504 adds a new entry to the matching table 506, in an operation 5906. However, when it is checked that the same SIP/DIP pair exists in the matching table 506, the analysis unit 504 compares the window size of the HTTP GET request message at present and a window size of an immediately preceding HTTP GET request message, in an operation 5908.

As a result of the comparison, when the window size of the current HTTP GET request message is not smaller than ½ of the window size of an immediately preceding HTTP GET request message, the method goes to an operation 5912 where the analysis unit 504 updates a window size of a corresponding SIP/DIP pair with the window size of the current HTTP GET request message.

As a result of the comparison, however, when the window size of the current HTTP GET request message is smaller than ⅓ to ½ of the window size of the immediately preceding HTTP GET request message, the method goes to an operation 5914 where the analysis unit 504 determines that it is the slow read DDoS attack. This is because that the window size cannot be adjusted below ½ of the window size even though it is reduced due to an omission of a transmission packet and the window size sent in the same SIP does not exhibit such a sudden change.

Similarly, as described in relation to FIG. 6, it may be efficient that a limit setting is applied based on the policy of an administrator depending on a case where the window size of the HTTP GET request message is smaller than the maximum MTU or a network environment. In addition, it is difficult to make the deletion of an entry in accordance with the management of a TCP connection, and, thus, a mechanism such as LRU may be applied to the deletion of the entry.

As described above, in the detection of the slow read DoS attack in a virtualized environment, in consideration of correlation and feature of a window size of a TCP SYN packet in a process of establishing a TCP connection required in HTTP connection and a window size of an HTTP GET request message transferred in the same session, HTTP GET request messages of a normal user and a malicious user are classified and reacted. Accordingly, it is possible to detect the slow read DOS attack more quickly, thereby protecting a web server from a web server overload attack such as the slow read DOS attack and providing a smooth service to the normal user.

While the description of the present invention has been made to the exemplary embodiments, various changes and modifications may be made without departing from the scope of the invention. The embodiment of the present invention is not limited thereto. Therefore, the scope of the present invention should be defined by the appended claims rather than by the foregoing embodiments.

What is claimed is:

1. A method for detecting a slow read DoS attack in a virtualized environment, the method comprising:
receiving a connection request packet transmitted from a client to a server using a web protocol;
checking whether the received packet is a TCP SYN packet or a packet of an HTTP GET request message;
when it is checked that the received packet is the packet of the HTTP GET request message, detecting whether the received packet is a packet for the slow read DoS attack by analyzing a window size of the HTTP GET request message.

2. The method of claim 1, wherein said detecting comprises:
when it is checked that the received packet is the HTTP GET request message, comparing the window size of the HTTP GET request message and a window size of the TCP SYN packet that has been stored previously; and
as a result of the comparison, when the window size of the HTTP GET request message is the same as the window size of the TCP SYN packet that has been stored previously, determining that the received packet is a packet for the slow read DoS attack.

3. The method of claim 2, wherein said detecting comprises:
as a result of the comparison, when the window size of the HTTP GET request message is smaller than the window size of the TCP SYN packet that has been stored previously, determining that the received packet is a packet for the slow read DoS attack.

4. The method of claim 1, wherein said detecting comprises:
when it is checked that the received packet is the HTTP GET request message, checking whether there exists the same SIP and DIP pair in the HTTP GET request message and a matching table;
when it is checked that there exists the same SIP and DIP pair in the HTTP GET request message and a matching table, comparing the window size of the HTTP GET request message and a window size of an immediately preceding HTTP GET request message; and
as a result of the comparison, when the window size of HTTP GET request message is less than or equal to a predetermined reference value relative to the window size of the immediately preceding HTTP GET request message, determining that the received packet is a packet for the slow read DoS attack.

5. The method of claim 4, wherein said determining comprises:
when the window size of the HTTP GET request message is less than or equal to 0.3 to 0.5 times the window size of an immediately preceding HTTP GET request message.

6. The method of claim 1, wherein said checking comprises:
when it is checked that the received packet is the TCP SYN packet, constituting a new entry in a matching table.

7. An apparatus for detecting a slow read DoS attack in a virtualized environment, the apparatus comprising:
a receiving unit configured to receive a packet that requests a connection with a server from a client using a web protocol; and
an analysis unit configured to analyze, when the received packet is an HTTP GET request message, a window size of the HTTP GET request message to detect whether the received packet is a packet for the slow read DoS attack.

8. The apparatus of claim 7, wherein the analysis unit is configured to:
compare, when the packet received from the receiving unit is the HTTP GET request message, a window size of the HTTP GET request message and a window size of a TCP SYN packet that has been stored previously; and
determine, when the window size of the HTTP GET request message is the same as that of the TCP SYN packet, that the received packet is a packet for the slow read DoS attack.

9. The apparatus of claim 7, wherein the analysis unit is configured to:
compare, when the packet received from the receiving unit is the HTTP GET request message, the window size of the HTTP GET request message and the window size of the TCP SYN packet that has been stored previously; and
determine, when the window size of the HTTP GET request message is smaller than that of the TCP SYN packet that has been stored previously, determining that the received packet is a packet for the slow read DoS attack.

10. The method of claim 7, wherein the analysis unit is configured to:
compare, when the packet received from the receiving unit is the HTTP GET request message and there exists the SIP and DIP pair in the HTTP GET request message and a matching table, the window size of the HTTP GET request message and a window size of an immediately preceding HTTP GET request message; and
determine, when the window size of the HTTP GET request message is smaller than or equal to a predetermined reference value relative to the window size of the immediately preceding HTTP GET request message, that the received packet is a packet for the slow read DoS attack.

11. The apparatus of claim 10, wherein the receiving unit is configured to:
determine, when the window size of the HTTP GET request message is less than or equal to 0.3 to 05 times the window size of the immediately preceding GET request message, that the received packet is a packet for the slow read DoS attack.
